(19) United States
(12) Patent Application Publication
(10) Pub. No.: US 2007/0083307 A1
(43) Pub. Date: Apr. 12, 2007

(54) Method and apparatus for monitoring an oxygen sensor

(75) Inventors: Matthew Gerald Pasztor, Kalamazoo, MI (US); Robert Kochie, Mantorville, MN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/244,240

(22) Filed: Oct. 6, 2005

(51) Int. Cl. G06F 19/00

(52) U.S. Cl. 701/34; 701/29

(57) ABSTRACT

A method of monitoring an oxygen sensor. The method includes collecting a set of data points from the oxygen sensor and identifying a number of parameters based on the set of data points collected. In turn, these parameters may be used to calculate a reaction time of the oxygen sensor. Also, a diagnostic tool for implementing the method.

### FIELD OF THE INVENTION

The present invention relates generally to diagnostic tools and methods for operating diagnostic tools. More particularly, the present invention relates to methods for monitoring oxygen sensors and to apparatuses for implementing such methods.

### BACKGROUND OF THE INVENTION

Oxygen sensors are commonly used to monitor oxygen levels in a wide variety of engines. For example, the engines of cars, trucks, boats and other vehicles typically contain oxygen sensors that monitor the oxygen/fuel ratios in the piston chambers of the engines.

When relying on data obtained from an oxygen sensor, the response time of the oxygen sensor should be within a certain specified range. Otherwise, the collected data may be meaningless. For example, if the reaction time of an oxygen sensor is too slow, the sensor will not have enough time to fully carry out a sensing operation. At least for this reason, methods for checking the response times of oxygen sensors have been developed.

According to one such method, an oscilloscope is operably connected to the oxygen sensor to be tested and the oscilloscope displays “live” or “real-time” data received from the sensor as a function of time. Then, the screen of the oscilloscope is frozen (i.e., data collection is stopped and the display is placed in a static mode). Thereafter, data points at several predefined voltage levels are identified on the display and the times at which those data points were collected are read from the display.

Unfortunately, when implementing the above-discussed method, a user must look at the display and approximate both the positions of the data points and the times at which those data points were collected. Therefore, a significant amount of uncertainty is introduced into the calculation of the response time of the oxygen sensor.

At least in view of the above, it would be desirable to develop new methods for calculating the response times of oxygen sensors, wherein the new methods would reduce the amount of uncertainty in the calculations. It would also be desirable to develop new diagnostic tools configured to implement such methods.

### SUMMARY OF THE INVENTION

The foregoing needs are met, to a great extent, by certain embodiments of the present invention. According to one such embodiment, a diagnostic tool is provided. The diagnostic tool includes an interface configured to receive a set of data points collected by an oxygen sensor at a set of times. The diagnostic tool also includes a processor that is operably connected to the interface and that is configured to identify a first data point and a second data point in the set of data points based on defined parameters. The processor is also configured to determine a time difference between a first time at which the first data point was collected and a second time at which the second data point was collected.

According to another embodiment of the present invention, a method of monitoring an oxygen sensor is provided. The method includes connecting a diagnostic tool to an oxygen sensor to collect a set of data points from the oxygen sensor. The method also includes identifying, within the diagnostic tool and based on the set of data points, parameters for calculating a reaction time of the oxygen sensor.

According to yet another embodiment of the present invention, another diagnostic tool is provided. The diagnostic tool includes connecting means for connecting a diagnostic tool to an oxygen sensor to collect a set of signals from the oxygen sensor. The diagnostic tool also includes identifying means for identifying, within the diagnostic tool and based on the set of signals, parameters for calculating a reaction time of the oxygen sensor. The identifying means is operably connected to the connecting means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic view of a system according to an embodiment of the present invention wherein a diagnostic tool is connected to an oxygen sensor in a vehicle.

FIG. 2 is a flowchart illustrating steps that may be followed in accordance with an embodiment of a method of monitoring an oxygen sensor according to the present invention.

FIG. 3 is a schematic view of a display of a diagnostic tool according to an embodiment of the present invention.

FIG. 4 is a schematic view of a display of a diagnostic tool according to another embodiment of the present invention.

FIG. 5 is a schematic view of a display of a diagnostic tool according to yet another embodiment the present invention.

FIG. 6 is a schematic view of a display of a diagnostic tool according to still another embodiment of the present invention.

### DETAILED DESCRIPTION

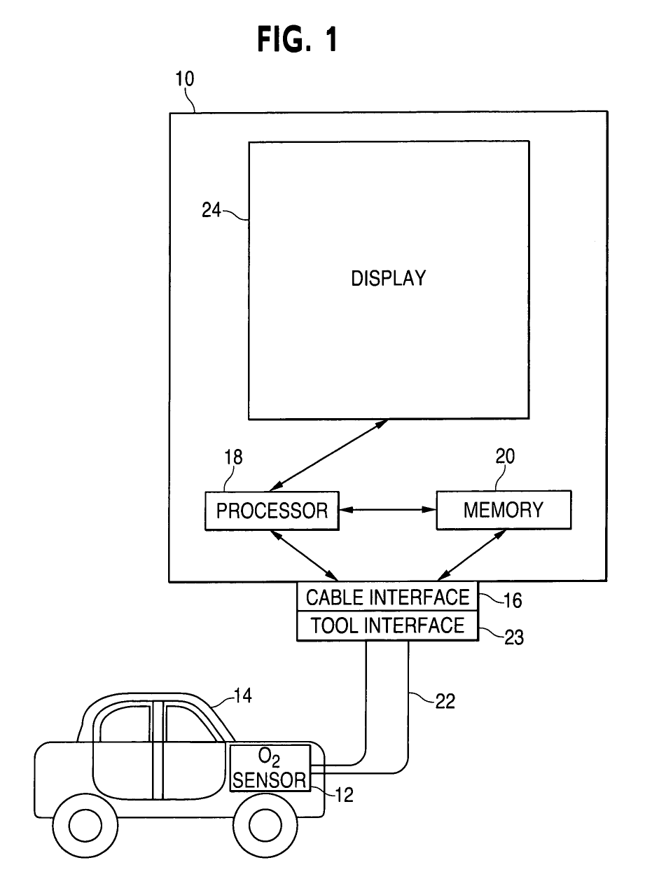

The invention will now be described with reference to the drawing figures, in which like reference numerals refer to like parts throughout. FIG. 1 is a schematic view of a system according to an embodiment of the present invention, wherein a diagnostic tool 10 is connected to an oxygen sensor 12 in a vehicle 14. The diagnostic tool 10 illustrated in FIG. 1 includes a cable interface 16 that is configured to receive a set of data points collected by the oxygen sensor 12 at a set of times. The diagnostic tool 10 illustrated in FIG. 1 also includes a processor 18 that is operably connected to the cable interface 16. In addition, the diagnostic tool 10 includes a memory 20 that is operably connected to the processor 18 and to the cable interface 16 and that is configured to store the above-mentioned set of data points.

According to certain embodiments of the present invention, the processor 18 is capable of storing enough data therein to implement methods according to the present invention. However, when the processor 18 becomes unable to store enough data therein, the memory 20 may be used.

As illustrated in FIG. 1, a cable 22 extends between the oxygen sensor 12 in the vehicle 14 and the diagnostic tool 10. The cable 22 interfaces with the cable interface 16 of the diagnostic tool 10 using a tool interface 23 and interfaces with the oxygen sensor 12 using a sensor interface (not illustrated) that is easily removable from the sensor 12.

Also illustrated as included in the diagnostic tool 10 in FIG. 1 is a display 24 which may take the form, for example, of a liquid crystal display (LCD), a light emitting diode (LED) display, or of a video graphics array (VGA). Typically, the display 24 is used to provide information to the user of the diagnostic tool 10 and, as will be discussed below, the display 24 is typically configured to display several different types of data.

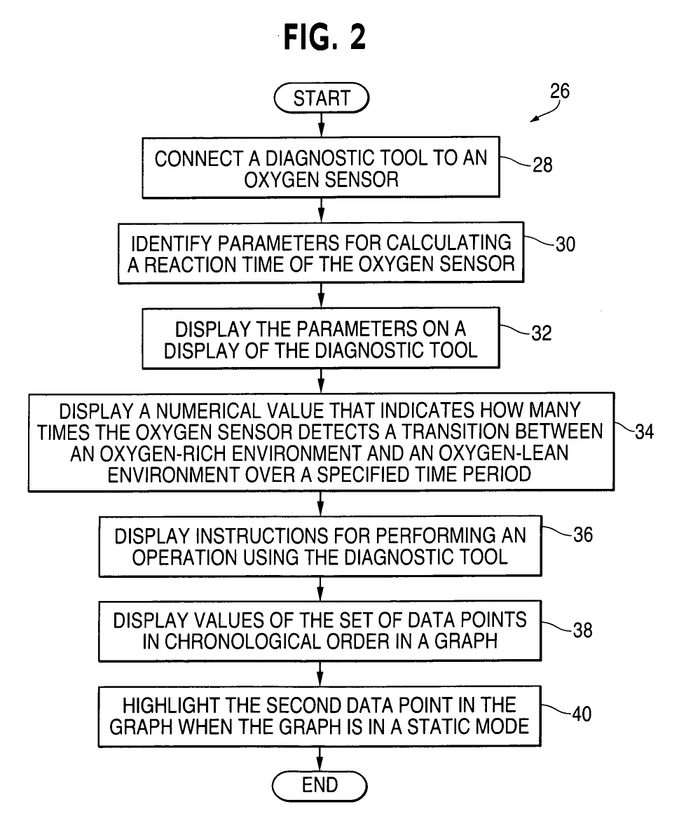

FIG. 2 is a flowchart 26 illustrating steps that may be followed in accordance with an embodiment of a method of monitoring an oxygen sensor according to the present invention. The method whose steps are illustrated in the flowchart 26 may be implemented, for example, using a hand-held version of the diagnostic tool 10 illustrated in FIG. 1.

The first step 28 in the flowchart 26 specifies connecting a diagnostic tool to an oxygen sensor. This connecting step 28 may be implemented, for example, by connecting the diagnostic tool 10 to the oxygen sensor 12 in the vehicle 14 as illustrated in FIG. 1.

Typically, the connecting step 28 also includes collecting a set of data points from the oxygen sensor 12. This set of data points is typically collected by the oxygen sensor 12 over a period of time and may include, for example, voltage levels, current levels, count levels and times at which readings were taken by the oxygen sensor 12.

The second step 30 in flowchart 26 specifies identifying parameters for calculating a reaction time of the oxygen sensor. This identifying step 30 may be implemented, for example, within the diagnostic tool 10 illustrated in FIG. 1. Typically, the identifying step 30 is implemented based upon the set of data points collected pursuant to the above-discussed connecting step 28 having been performed.

The identifying step 30, according to certain embodiments of the present invention, includes arranging the data points in the above-discussed set of data points in chronological order. In other words, data points that correspond to earlier readings taken by the oxygen sensor 12 illustrated in FIG. 1 are positioned at the front end of the set of data points and data points that correspond to later readings taken by the oxygen sensor 12 are placed towards the end of the set of data points.

Pursuant to arranging the data points in chronological order, the identifying step 30 typically includes locating a first data point having a value above a first specified value. In order to locate this first data point, the data points are analyzed in reverse chronological order (i.e., at the data point corresponding to the last reading taken by the oxygen sensor 12) until one of the data points is found to exceed a first specified value. The first specified value may vary, for example, with the type of oxygen sensor used and the geometry of the enclosure in which the oxygen sensor is positioned. However, according to certain embodiments of the present invention, the first value can correspond to 0.8 volts. Thus, according to these embodiments, implementation of the identifying step 30 includes identifying the first data point having a value above 0.8 volts, starting from the last-collected data point.

According to the identifying step 30, once the first data point has been found, the set of data points is then searched, starting from the first data point and proceeding in reverse chronological order, until a second data point having a value below a second specified value is identified. The time at which the second data point was collected by the oxygen sensor 12 then becomes a first parameter that may be used for calculating the reaction time of the oxygen sensor 12.

Like the first specified value, the second specified value will be system dependant and depends at least on the type of oxygen sensor used and the geometry of the enclosure in which the oxygen sensor is positioned. However, according to certain embodiments of the present invention, the second specified value is equal to 0.175 volts. According to some of these embodiments, once a first data point having a value above 0.8 volts is found towards the end of the chronologically ordered set of data points, a search is conducted in reverse chronological order until a second data point having a value below 0.175 volts is identified.

Once the second data point has been identified, implementation of the identifying step 30 illustrated in the flowchart 26 then includes searching the set of data points in chronological order, starting from the second data point, until a third data point having a value above the first specified value is identified. The time at which the third data point was collected by the oxygen sensor 12 then becomes a second parameter that may be used for calculating the reaction time of the oxygen sensor 12.

In the above-discussed example, a search is typically conducted, starting from the second data point having a value below 0.175 volts, until a third data point having a value above 0.8 volts is identified. In some instances, the third data point and the first data point will be identical. However, this is not always the case.

The identifying step 30 also typically includes determining a time interval between collection by the oxygen sensor of the second data point and of the third data point. In order to make such a determination, the time at which the second data point was collected by the oxygen sensor 12 illustrated in FIG. 1 is merely subtracted from the time at which the oxygen sensor 12 collected the third data point.

When the identifying step 30 illustrated in the flowchart 26 is implemented using the diagnostic tool 10 illustrated in FIG. 1, the processor 18 is typically configured to identify the above-discussed first, second and third data points in the set of data points based on the defined parameters (e.g. the first specified value and the second specified value). The processor 18 is also typically configured to determine the time difference between a first time at which the second data point was collected and a second time at which the above-discussed third data point was collected.

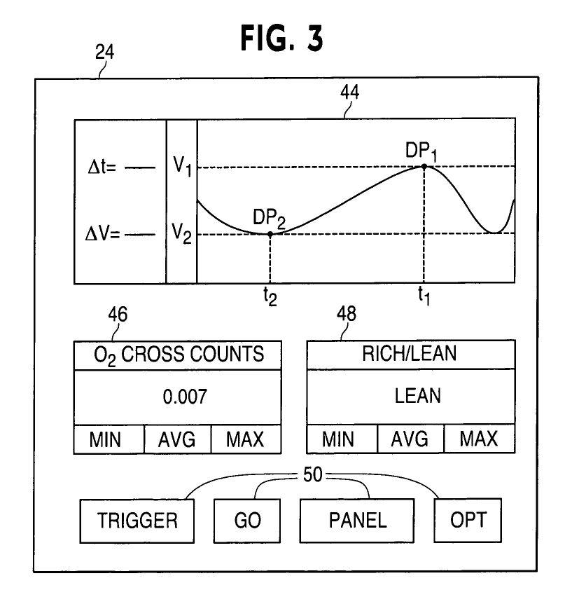

The third step 32 of the flowchart 26 illustrated in FIG. 2 specifies displaying the above-discussed parameters on a display of the diagnostic tool. The displaying step 32 may be implemented, for example, on the diagnostic tool 10 illustrated in FIG. 1 by using the display 24. FIGS. 3-6 are schematic views of various displays of a diagnostic tool according to certain embodiments of the present invention. Two or more of the views included in FIGS. 3-6 may usually be implemented on the display of a single diagnostic tool. Typically, one or more buttons allow for the display to toggle between the two or more views.

It should be noted that, as an alternative to displaying the parameters on a display of the diagnostic tool, information about one or more of the parameters may be forwarded to a location other than the display. For example, information about one or more of the parameters may be sent from the processor 18 to a remote computer or controller.

The schematic view of the display 24 in FIG. 3 includes an oscilloscope region 44 that comprises a graph of a set of data points arranged in chronological order. In FIG. 3, the display is static or “frozen” (i.e., does not illustrate data currently being collected by the oxygen sensor 12) and the set of data points form a roughly sinusoidal curve.

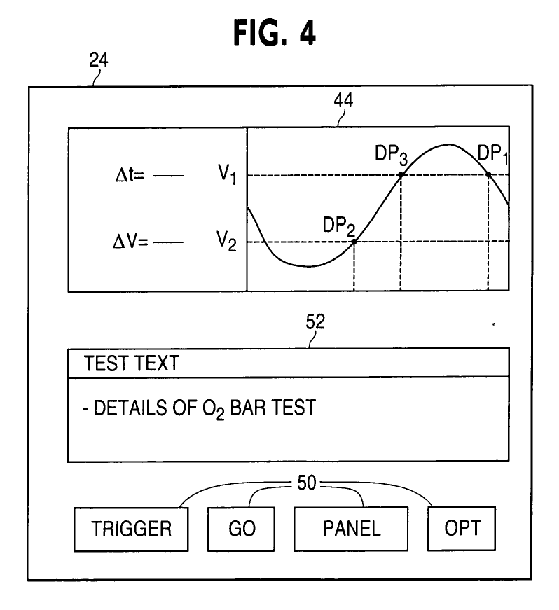

In the oscilloscope region 44 illustrated in FIG. 3, the vertical axis on the left-hand side of the graph includes a first voltage value identified as V₁ and a second voltage value identified as V₂. A dotted line extends horizontally from each of these voltage values, V₁ and V₂, and intersect the curve of data points at a first data point, DP₁, and at a second data point, DP₂. The first data point, DP₁, in this example, corresponds to both the first and third data points identified when implementing the above-discussed identifying step 30 in the flowchart 26 of FIG. 2 and the second data point, DP₂, corresponds to the second data point identified when implementing the same identifying step 30. However, as illustrated in FIG. 4, the first, second and third data points DP₁, DP₂, DP₃ may be at different locations.

Extending downward from each of the two data points, DP₁, and DP₂, are vertical dotted lines that identify a first time value, t₁, at which the first data point DP₁, was collected by the oxygen sensor 12 and a second time value, t₂. at which the second data point DP₂ was collected by the oxygen sensor 12. To the left of the graph in the oscilloscope region 44 is shown a value, Δt, for the time interval between the first time value, t₁, and the second time value, t₂. Also shown to the left of the graph in the oscilloscope region 44 is a value, ΔV, for the difference between the first voltage value V₁ and the second voltage value V₂.

The display 24 illustrated in FIG. 3 also includes an oxygen cross-count region 46 that indicates how many times the voltage value of the sensor 12 crosses a specified value (e.g., 0.45 V) over a specified time period (e.g., 4 seconds). When the specified voltage value is chosen to coincide with a transition point between the detection of an oxygen-rich environment and an oxygen-lean environment, the region 46 indicates how many times the sensor detects a transition between these two types of environments over the specified time period.

In addition, the display 24 illustrated in FIG. 3 includes a RICH/LEAN indicator region 48 that identifies whether the environment being sensed by the oxygen sensor 12 in the vehicle 14 is oxygen-rich or oxygen-lean at a give time. Also illustrated in FIG. 3 are a plurality of buttons 50 that may be used to toggle between the schematic views of the various displays illustrated in FIGS. 3-6. In other words, the buttons 50 may be used to alter the appearance of the display 24 in a variety of manners that will be discussed below. For example, the “Go” button 50 may be used to toggle between the oscilloscope region 44 showing live data and being frozen.

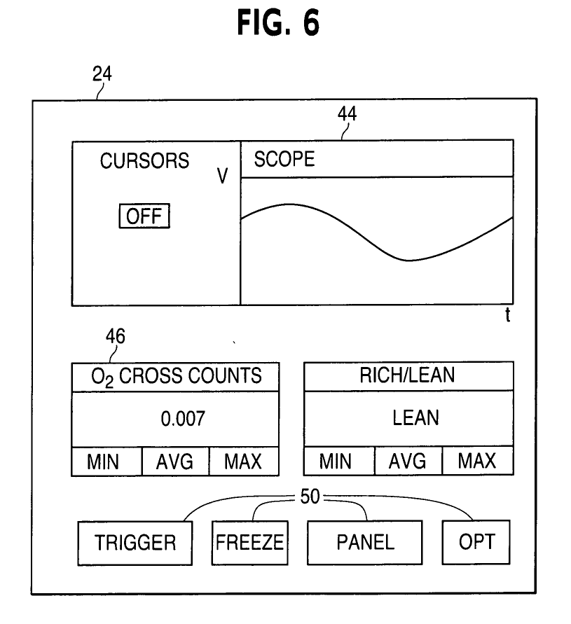

Returning to the flowchart 26 illustrated in FIG. 2, the fourth step 34 included therein specifies displaying a numerical value that indicates how many times the oxygen sensor 12 detects a transition between an oxygen-rich and an oxygen-lean environment over a specified time period. As discussed above, this displaying step 34 may be implemented on the diagnostic tool 10 illustrated in FIG. 1 and corresponds to the numerical value included in the oxygen cross-count region 46 illustrated in FIGS. 3 and 6.

As mentioned above, the oscilloscope region 44 illustrated in FIG. 3 is static or frozen. As such, the first data point DP₁, and the second data point DP₂ are spatially fixed in the oscilloscope region 44 illustrated in FIG. 3. Therefore, in addition to or in lieu of the dotted horizontal and vertical lines illustrated in FIG. 3, cursors, symbols or other methods may be used to highlight data points in the graph.

The fifth step 36 included in the flowchart 26 in FIG. 2 specifies displaying instructions for performing an operation using the diagnostic tool. This displaying step 36 may be implemented on the display 24 of the diagnostic tool 10 as illustrated in FIG. 4, where a text display portion 52 is included as part of the display 24. According to certain embodiments of the present invention, text and/or images related to instructions for performing an operation using the diagnostic tool 10 may be displayed in the text display portion 52. For example, text and/or images instructing a user on how to carry out a test procedure using the oxygen sensor 12 may be included in the text display portion 52. In order to toggle the display 24 of the diagnostic tool 10 between the configurations illustrated in FIGS. 3 and 4, the “Panel” button 50 may be pushed.

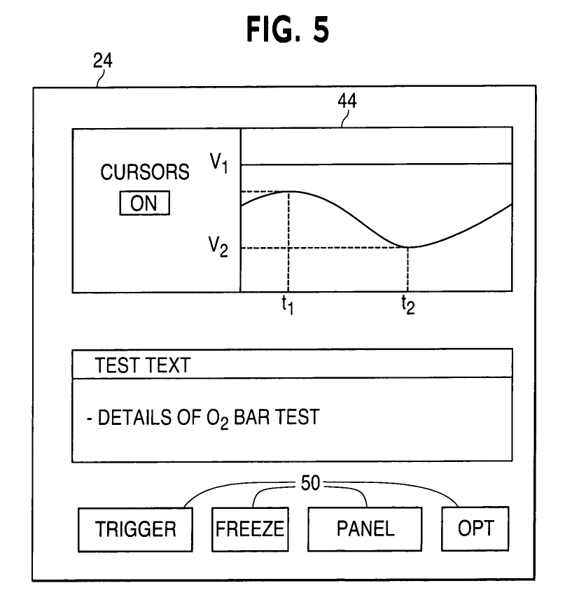

The sixth step 38 in the flowchart 26 illustrated in FIG. 2 specifies displaying values of the set of data points in chronological order in a graph. When implemented using the diagnostic tool 10 illustrated in FIG. 1, the display 24 may be configured to display the above-discussed graph in the oscilloscope region 44 in FIG. 3, wherein the graph is displayed in a static or frozen mode. When it is preferred to display live data as it is being received from the oxygen sensor 12, the oscilloscope region 44 may be configured to appear as it does in FIGS. 5 and 6. In order to implement the displaying step 38, the graph typically displays voltage values versus time, as shown in FIGS. 3 and 4. However, other values (e.g., current) versus time may also be displayed.

The seventh step 40 illustrated in the flowchart 26 in FIG. 2 specifies highlighting the second data point in the graph when the graph is in a static mode. In FIGS. 3 and 4, each of the data points DP₁, and DP₂ are highlighted by having dotted lines intersect thereon. However, as mentioned above, other methods of highlighting the data points are also within the scope of the present invention. For example, the data points may be highlighted through the use of cursors, marker, shading, coloration, etc.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A diagnostic tool, comprising:
an interface configured to receive a set of data points collected by an oxygen sensor at a set of times; and
a processor operably connected to the interface and configured
to identify a first data point and a second data point in the set of data points based on defined parameters, and
to determine a time difference between a first time at which the first data point was collected and a second time at which the second data point was collected.

2. The diagnostic tool of claim 1, further comprising:
a display operably connected to the processor and configured to display a numerical value that corresponds to the time difference.

3. The diagnostic tool of claim 2, wherein the display is further configured to display a numerical value that indicates how many times the oxygen sensor detects a transition between an oxygen-rich and an oxygen-lean environment over a specified time period.

4. The diagnostic tool of claim 2, wherein the display is further configured to display instructions for performing an operation using the diagnostic tool.

5. The diagnostic tool of claim 2, wherein the display is further configured to indicate whether the sensor is sensing an oxygen-lean environment.

6. The diagnostic tool of claim 2, wherein the display is further configured to include a graph of values of the set of data points versus the set of times.

7. The diagnostic tool of claim 6, wherein the display is further configured to display the graph in a static mode.

8. The diagnostic tool of claim 7, wherein the display is further configured to highlight the first data point in the graph when the graph is displayed in the static mode.

9. The diagnostic tool of claim 6, wherein the display is configured to display the graph using voltage levels as the values of the set of data points.

10. The diagnostic tool of claim 1, further comprising:
a memory operably connected to the processor and configured to store the set of data points.

11. The diagnostic tool of claim 1, further comprising:
a cable interface operably connected to the processor and configured to provide a connection between the diagnostic tool and a cable configured to be operably connected to the cable interface and to the oxygen sensor.

12. A method of monitoring an oxygen sensor, the method comprising:
connecting a diagnostic tool to an oxygen sensor to collect a set of data points therefrom; and
identifying, within the diagnostic tool and based on the set of data points, parameters for calculating a reaction time of the oxygen sensor.

13. The method of claim 12, further comprising:
displaying the parameters on a display of the diagnostic tool.

14. The method of claim 12, further comprising:
displaying, on a display of the diagnostic tool, a numerical value that indicates how many times the oxygen sensor detects a transition between an oxygen-rich environment and a oxygen-lean over a specified time period.

15. The method of claim 12, further comprising:
displaying, on a display of the diagnostic tool, instructions for performing an operation using the diagnostic tool.

16. The method of claim 12, wherein the identifying step comprises:
arranging data points in the set of data points in chronological order;
locating, from an end of the chronological order, a first data point having a value above a first specified value;
searching the set of data points in reverse chronological order, starting with the first data point, until a second data point having a value below a second specified value is identified;
searching the set of data points in chronological order, starting with the second data point, until a third data point having a value above the first specified value is identified; and
determining a time interval between collection by the oxygen sensor of the second data point and the third data point.

17. The method of claim 16, further comprising:
displaying values of the set of data points in chronological order in a graph.

18. The method of claim 17, further comprising:
highlighting the second data point in the graph when the graph is in a static mode.

19. A diagnostic tool, comprising:
connecting means for connecting a diagnostic tool to an oxygen sensor to collect a set of signals therefrom; and
identifying means for identifying, within the diagnostic tool and based on the set of signals, parameters for calculating a reaction time of the oxygen sensor, wherein the identifying means is operably connected to the connecting means.

20. The diagnostic tool of claim 19, further comprising:
displaying means for displaying the parameters, wherein the displaying means is operably connected to the identifying means.
